(19) United States
(12) Patent Application Publication
(10) Pub. No.: US 2009/0050678 A1
(43) Pub. Date: Feb. 26, 2009

(54) METHOD FOR MOUNTING ELECTRONIC PARTS

(75) Inventor: Naoyuki YAMAMOTO, Saitama (JP)

Correspondence Address: CANTOR COLBURN, LLP, 20 Church Street, 22nd Floor, Hartford, CT, 06103, US

(73) Assignee: NIHON DEMPA KOGYO CO., LTD., Tokyo (JP)

(21) Appl. No.: 12/194,330

(22) Filed: Aug. 19, 2008

(30) Foreign Application Priority Data
Aug. 22, 2007 (JP) 2007-215535

(51) Int. Cl. B23K 31/02

(52) U.S. Cl. 228/180.22

(57) ABSTRACT

When a surface-mount electronic part, which includes at least two mounting electrodes on an external underside thereof, is bonded to circuit terminals on a wiring board using solder, a protrusion, which is thicker than the circuit terminal, is provided on a surface of the wiring board facing the outer bottom surface of the electronic part to have the clearance between the mounting electrode and the circuit terminal that is not smaller than a predetermined value, so that the thickness of the solder between the mounting electrode and the circuit terminal is maintained to be large.

### BACKGROUND OF THE INVENTION

1. Field of the Invention

The present invention relates to a method for mounting a surface mount electronic part on a wiring board or a circuit board, and more particularly, to a mounting method for preventing the occurrence of a crack, such as a solder crack or fracture, due to a difference between coefficients of thermal expansion of an electronic part and a wiring board.

2. Description of the Related Arts

A surface-mount electronic part is generally small and lightweight, and for example, is used for high density mounting on a wiring board or a circuit board The surface-mount electronic part is mounted on the wiring board with reflow-soldering, or the like. A surface-mount crystal device, in which a quartz crystal blank is hermetically enclosed in a surface-mount package, is known as an example of the surface-mount electronic part, and includes a surface-mount crystal unit. In the surface-mount crystal unit, the crystal blank is hermetically enclosed in the package, and mounting terminals, which are electrically connected to excitation electrodes provided on the crystal blank, are formed in an outer bottom surface of the package The surface-mount crystal unit is, for example, used for an apparatus controlling an engine of an automobile. However, when the surface-mount crystal unit is used in an apparatus mounted on the automobile, the ambient temperature is significantly changed, so that the thermal expansion of the wiring board in which the crystal unit is mounted, and the thermal expansion of the crystal unit itself are largely different from each other, and a solder layer, which fixes the crystal unit on the wiring board, may be cracked or broken.

FIG. 1A illustrates such a state that the surface-mount crystal unit, which is the surface-mount electronic part, is mounted on the wiring board. In this crystal unit, quartz crystal blank 2 is contained in flat and substantially-parallelepiped hermetic package 1. Hermetic package 1 is, for example, configured with package body 3, which is made of laminated ceramics, and in which a concavity portion is formed in one main surface, and cover 4, which is made of ceramic, and is flat plate-like. A pair of crystal holding terminals (not shown) are, for example, provided in one end portion of the internal bottom surface of the concavity of package body 3. As illustrated in FIG. 1B, mounting electrode 5 is provided in each central portion of a pair of short sides of the outer bottom surface of package body 3. Mounting electrodes 5 are used when this crystal unit is surface-mounted on a wiring board, and are provided as an electrode layer. A pair of mounting electrodes 5 are electrically connected to a pair of the crystal holding terminals respectively through a laminated plane between ceramic sheets in package body 3.

Crystal blank 2 is an AT-cut quartz crystal blank having a substantially rectangular shape, and the excitation electrode is formed on each of both main surfaces of crystal blank 2. Extending electrodes are extended from a pair of the exciting electrodes to both sides of one end of crystal blank 2. The extending electrodes are, for example, fixed to the crystal holding terminals with conductive adhesive 6 at a position at which a pair of the extending electrodes are led. Crystal blank 2 is thus held in the concavity of package body 3, and is electrically connected to mounting electrodes 5.

Cover 4 is, for example, bonded to an upper surface of package body 3, that is, a side surrounding the concavity by using low melting point glass. Thereby, the concavity is closed by cover 4, and crystal blank 2 is hermetically contained in the concavity.

Next, the surface-mount crystal unit completed as described above is mounted on wiring board 7 with the reflow soldering. Circuit terminals 8, which correspond to mounting electrodes 5 of the crystal unit, are provided as wiring pattern on a surface of wiring board 7. Cream solder is applied on each circuit terminal 8 by a printing method, the crystal unit is arranged so that mounting electrodes 5 are positioned on respective circuit terminals 8 through the cream solder, and after that, the crystal unit is transferred in a high-temperature furnace together with wiring board 7. As a result, since the cream solder is melted, each mounting electrode 5 is connected to circuit terminal 8 through solder layer 9, and the crystal unit is surface-mounted on wiring board 7 along with other electronic parts such as a resister and a condenser. Wiring board 7 is generally configured with a glass-fiber epoxy laminate.

However, when the above crystal unit is surface-mounted on wiring board 7, a problem may be induced attributed to a difference of the thermal expansion between package body 3, which is made of ceramic, of the crystal unit, and wiring board 7 configured with the glass epoxy laminate. The coefficient of thermal expansion of the ceramic configured in package body 3 is 7 to 8×10⁻⁶/° C., and the coefficient of thermal expansion of the glass epoxy laminate configured in wiring board 7 is 14×10⁻⁶/° C., so that the coefficient of thermal expansion of wiring board 7 is larger than that of package body 3 of the crystal unit.

When the surface-mount crystal unit is used for an engine controlling apparatus provided in an engine room of an automobile, both wiring board 7 and the crystal unit repeat the expansion and contraction due to the thermal expansion because of a heat cycle from a temperature increase when an engine is operating to a temperature decrease when the engine is stopped. In FIG. 1A, the expansion due to change in temperature is illustrated by an arrow. In this case, the amount of the expansion and contraction of the crystal unit is different from that of wiring board 7 because of the difference of the coefficients of thermal expansion, so that a mechanical strain is induced in each of the crystal unit and wiring board 7.

Such strains are propagated to solder 9 which bonds the crystal unit to wiring board 7, and stress is induced in solder 9. This stress can not be completely absorbed by the flexibility of solder 9, and as illustrated in FIG. 2, crack 10 is induced in solder 9. FIG. 2 is an expanded view of a portion indicated by sign P in FIG. 1A. If crack 10 is thus induced in solder 9, a contact failure, that is, an electrical conduction failure between mounting electrodes 5 and circuit terminals 8, or the peel-off of the crystal unit from wiring board 7 may be induced.

Japanese Patent Laid-Open No. 2004-72637 (JP-A-2004-072637) discloses that a thick copper layer is provided on the mounting electrode in the crystal unit, and the copper layer and the circuit terminal on the wiring board are reflow-soldered, thereby, the difference of the thermal expansion between the crystal unit and the wiring board is absorbed by the copper layer, and the connection reliability between the mounting electrode and the circuit terminal is improved. However, in this method, since a process is necessary which provides a copper layer or a copper plate on the mounting electrode, a process for manufacturing the crystal unit becomes complex, and a production cost is also largely increased. This is a problem.

### SUMMARY OF THE INVENTION

An object of the present invention is to provide a method for mounting a surface-mount electronic part on a wiring board so that a crack is not induced in solder which bonds the electronic part to the wiring board even when there is a difference of the coefficient of thermal expansion between the electronic part and the wiring board.

The object of the present invention is achieved by a method for bonding a surface-mount electronic part, which has at least two mounting electrodes on an outer bottom surface thereof, to circuit terminals on a wiring board using solder, wherein a protrusion that is thicker than the circuit terminal is provided on a surface of the wiring board facing the outer bottom surface of the electronic part to have clearance between the mounting electrode and the circuit terminal that is not smaller than a predetermined value, so that the thickness of the solder between the mounting electrode and the circuit terminal is maintained.

In the present invention, the mounting electrode and the circuit terminal are, for example, bonded by a reflow-soldering method. In the present invention, the solder is not limited to solder which is alloy of lead (Pb) and tin (Sn), and may be a wide variety of lead-free (Pb-free) solder.

In such a configuration, the thickness of the solder can be maintained to be large because of the protrusion or projection portion which is thicker than the circuit terminal. Since the thickness of the solder layer is larger, it is possible to absorb, by using solder, the stress because of the difference of the coefficient of thermal expansion between the electronic part and the wiring board, and to prevent the occurrence of the crack in the solder layer.

### BRIEF DESCRIPTION OF THE DRAWINGS

FIG. 1A is a cross-sectional view illustrating a state in which a surface-mount crystal unit is mounted on a wiring board by a conventional method;

FIG. 1B is a diagram illustrating an outer bottom surface of the crystal unit;

FIG. 2 is an expanded cross-sectional view illustrating a bonding portion between the crystal unit and the wiring board;

FIG. 3A is a cross-sectional view illustrating a state in which a surface-mount crystal unit is mounted on a wiring board by a mounting method according to an embodiment according of the present invention;

FIG. 3B is a plan view of the wiring board;

FIG. 4 is a cross-sectional view illustrating a state in which the surface-mount crystal unit is mounted on the wiring board, and a difference of the thermal expansion is induced;

FIGS. 5A and 5B are plan views illustrating other examples of the arrangement on the surface of the wiring board; and

FIG. 6 is a plan view illustrating a further example of the arrangement on the surface of the wiring board.

### DETAILED DESCRIPTION OF THE PREFERRED EMBODIMENTS

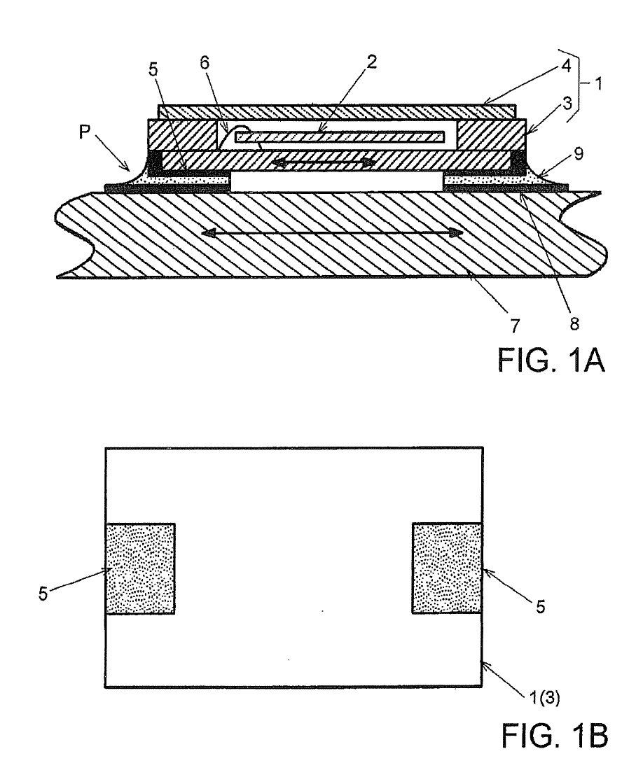

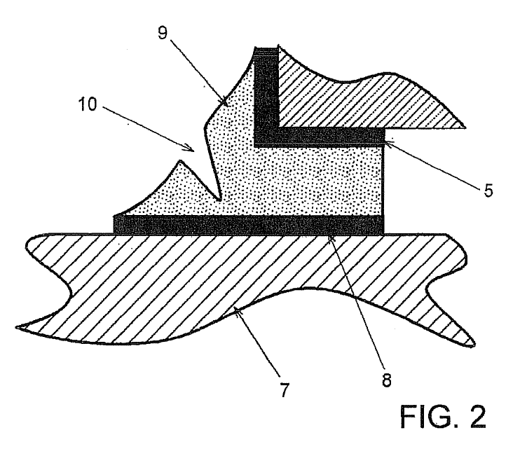

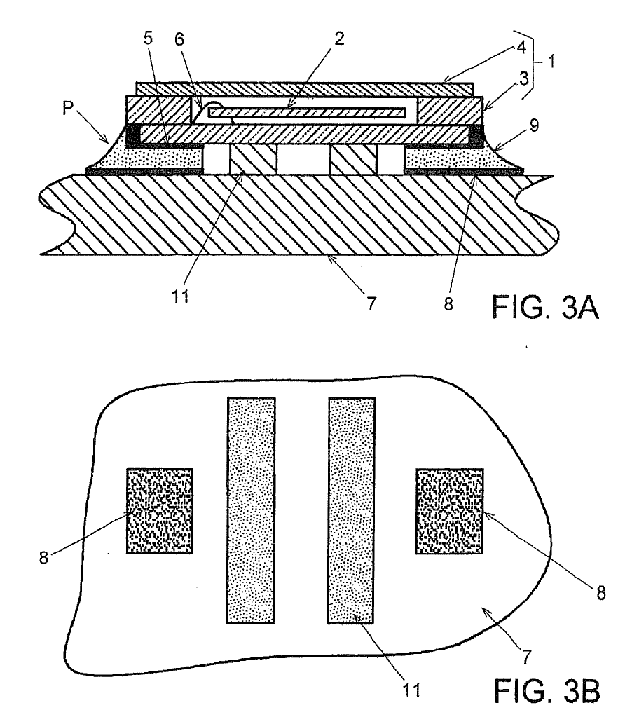

In FIGS. 3A and 3B for describing a mounting method according to an embodiment of the present invention, the same components as those in FIGS. 1A and 1B are denoted by the same reference numerals and duplicate descriptions will be omitted or simplified. Here, the surface-mount quartz crystal unit is addressed as an example of a surface-mount electronic part, and it is described that this crystal unit is surface-mounted on the wiring board, thereby, the mounting method of the present invention will be described.

In the same manner as described above, in the crystal unit illustrated in FIG. 3A, quartz crystal blank 2 is contained in hermetic package 1, hermetic package 1 is configured with package body 3, which is made of laminated ceramic and includes a concavity, and cover 4 made of ceramic. By bonding cover 4 to package body 3 by using low melting point glass, the concavity is closed by cover 4, and crystal blank 2 is hermetically accommodated the concavity. In the similar manner as shown in FIG. 1B, mounting electrode 5 is provided in each central portion of a pair of short sides of the outer bottom surface of hermetic package 1, that is, the outer bottom surface of package body 3. In such a configuration, mounting electrodes 5 are provided in both end portions of the outer bottom surface of package body 3. Mounting electrodes 5 are electrically connected to the extending electrodes of crystal blank 2.

As illustrated in FIG. 3B, a pair of circuit terminals 8 are provided as corresponding to positions of mounting electrodes 5 of the crystal unit on a surface of wiring board 7 configured with the glass-epoxy lamination board. In this embodiment, two lines of protrusions 11 or projection portions each having a strip-like shape or ridge shape, which are parallel to each other, are disposed in a central area between a pair of circuit terminals 8 on the surface of wiring board 7. A longitudinal direction of each protrusion 11 is perpendicular to a straight line connecting the pair of circuit terminals 8. Protrusion 11 is provided at each of left and right positions in the figure across a middle point of the pair of circuit terminals 8. The height of protrusion 11 from the surface of wiring board 7 is larger than the thickness of circuit terminal 8. Protrusion 11 is made of insulating material such as resin and glass, and is, for example, formed by a coating method, a printing method, or the like.

Since the height of protrusion 11 is larger than the thickness of circuit terminal 8, when the crystal unit is mounted on wiring board 7 without applying the cream solder, or the like, the crystal unit is maintained by protrusion 11 to be parallel to the surface of wiring board 7, and clearance is formed between mounting electrode 5 and circuit terminal 8.

In wiring board 7 in which two lines of projection parts 11 are formed as described above, the crystal unit is surface-mounted by the reflow-soldering. In the case, cream solder 9 is applied to each circuit terminal 8 of wiring board 7 by using the printing method. It is assumed that the thickness of the cream solder applied in this case is larger than the height of protrusion 11. Next, each mounting electrode 5 is contacted on cream solder 9 so that each mounting electrode 5 of the crystal unit is positioned at corresponding one of circuit terminals 8 on wiring board 7. On such a state, the crystal unit is transferred in a high-temperature furnace together with wiring board 7, cream solder 9 then melts, and thereby, circuit terminal 8 and mounting electrode 5 are bonded with the solder.

In this case, because of the scattering of flux, formation of solder fillet, and the own weight of the solder, the height of solder layer 9 becomes lower than the thickness of the cream solder when the cream solder is applied. However, since protrusion 11 is provided, the clearance between circuit terminal 8 and mounting electrode 5 does not become smaller than the predetermined value, so that the thickness of solder layer 9 is also maintained to be larger than that of the conventional case illustrated in FIGS. 1A and 1B. Generally, circuit terminal 8 and mounting electrode 5 are formed of a material with favorable wetting characteristics for solder, and the molten solder itself also includes the surface tension, so that, as long as the height of protrusion 11 is not extremely large, the molten solder continues to contact to both of circuit terminal 8 and mounting electrode 5. The molten solder is cooled on such a condition to be solidified, and circuit terminal 8 and mounting electrode 5 are electrically connected through solder 9.

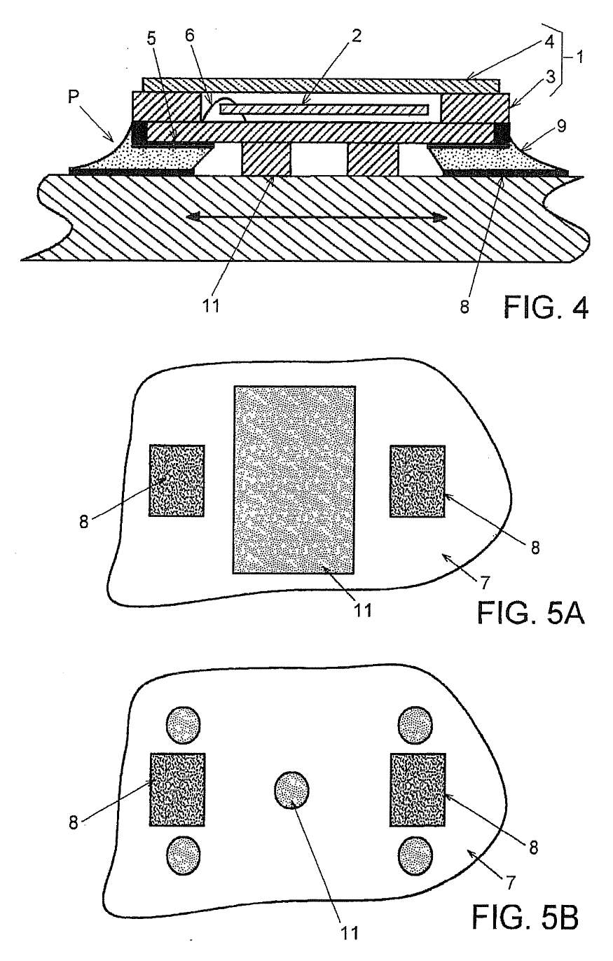

In the present embodiment, as compared with the conventional embodiment illustrated in FIGS. 1A and 1B, circuit terminal 8 and mounting electrode 5 are bonded on such a condition that the thickness of solder 9 is larger by provided protrusion 11. After the crystal unit is mounted on wiring board 7, even if the mechanical strain is applied between circuit board 7 and the crystal unit since a thermal shock or a heat cycle is applied, this strain is absorbed by solder 9 having an sufficient thickness. That is, as illustrated in FIG. 4, when wiring board 7 is extended larger than the crystal unit because of the thermal expansion, the solder of a side of wiring board 7 is also pulled in an illustrated external side direction, however, since the layer of solder 9 has a sufficient thickness, the strain induced between wiring board 7 and the crystal unit can be absorbed by such a pulling force applied to the solder. Thus, when the mounting method of the present embodiment is applied, it is possible to prevent the occurrence of the crack in the solder.

While the preferred embodiment of the present invention has been described, the plane arrangement of protrusion 11 provided on the surface of wiring board 7 is not limited to the above two-line arrangement. If the crystal unit can be stably held, as illustrated in FIG. 5A, only one strip-like and wide protrusion I1 may be provided. The shape of protrusion 11 is not limited to a strip shape. As illustrated in FIG. 5B, small circular protrusion or projection parts 11 may be also provided at five positions on wiring board 7 such that the five positions correspond to four corner portions and a center portion of the outer bottom surface of the crystal unit. That is, in the present invention, protrusion 11, whose height is larger than the height of circuit terminal 8, may be provided so that the crystal unit can be maintained to be parallel to the surface of wiring board 7 without being tilted.

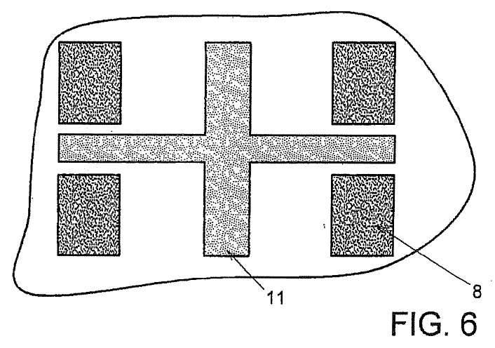

In the above description, while it is assumed that the surface-mount crystal unit includes two mounting electrodes 5, the crystal unit may be a crystal unit provided with mounting electrodes 5 in each of four corner portion of the outer bottom surface. In such a crystal unit, two of four mounting electrodes 5 are used as electrodes for grounding, and cover 4 made of metal is electrically connected to mounting electrodes 5 for grounding. In this case, for example, the crystal blank is electrically connected to mounting electrodes 5 allocated at both ends of one diagonal line in the outer bottom surface of the crystal unit, and mounting electrodes 5 allocated at both ends of the other diagonal line are used as a grounding electrode. Metallic cover 4 is, for example, bonded to package body 3 by a seam-welding or the like. As illustrated in FIG. 6, such a wiring board 7 mounting the crystal unit with four mounting electrodes 5 includes four circuit terminals 8 corresponding to mounting electrodes 5, and protrusion 11 whose planar shape is a cross shape.

The surface-mount crystal device, to which the present invention is applied, is not limited to the crystal unit. For example, the present invention can be applied to a surface-mount crystal oscillator in which a crystal blank and an IC chip integrating an oscillating circuit using this crystal blank are hermetically accommodated in a package. In this case, the number of mounting electrodes, which are provided in the outer bottom surface of the crystal oscillator, including an output terminal, a power terminal and a grounding terminal is four, and such mounting electrodes are provided at four corner portions of the outer bottom surface of the crystal oscillator. As in the case of the above FIG. 6, circuit terminals 8 and protrusion 11 are formed on the wiring board corresponding to such a crystal oscillator.

In the above description, while it is assumed that hermetic package 1 is configured with package body 3 including a concavity and flat cover 4. However, for example, the hermetic package may be configured by bonding a cover having a concavity to a package body which is formed in a flat shape. Here, it is meant that the package body is a package body in which surface-mount mounting electrodes are formed on the outer bottom surface thereof.

What is claimed is:

1. A mounting method for bonding a surface-mount electronic part, which has at least two mounting electrodes on an outer bottom surface thereof, to circuit terminals on a wiring board using solder,
wherein a protrusion that is thicker than the circuit terminal is provided 5 on a surface of the wiring board facing the outer bottom surface of the electronic part to have clearance between the mounting electrode and the circuit terminal that is not smaller than a predetermined value, so that the thickness of the solder between the mounting electrode and the circuit terminal is maintained.

2. The method according to claim 1, wherein the circuit terminal and the mounting electrode are bonded by the reflow-soldering.

3. The method according to claim 1,
wherein the electronic part is a surface-mount crystal device in which at least a crystal blank is contained in a package body made of ceramic, and the crystal blank is hermetically enclosed by covering a cover to the package body, and
the wiring board is configured with a glass-epoxy wiring board.

4. The method according to claim 1, wherein the mounting electrodes are provided on both end portions of the outer bottom surface of the surface-mount electric part.

5. The method according to claim 3, wherein the mounting electrodes are formed on both end portions in a longitudinal direction on the outer bottom surface of the package body.

6. The method according to claim 3, wherein the mounting electrodes are formed at four corner portions of the outer bottom surface of the package body.
